(19) United States
(12) Patent Application Publication
(10) Pub. No.: US 2013/0091489 A1
(43) Pub. Date: Apr. 11, 2013

(54) COMPUTING DEVICE, STORAGE MEDIUM AND METHOD FOR PROCESSING SOURCE FILES USING THE COMPUTING DEVICE

(71) Applicant: YING-CHUAN TSAI, Tu-Cheng (TW)

(72) Inventor: YING-CHUAN TSAI, Tu-Cheng (TW)

(73) Assignee: HON HAI PRECISION INDUSTRY CO., LTD., Tu-Cheng (TW)

(21) Appl. No.: 13/334,103

(22) Filed: Dec. 22, 2011

(30) Foreign Application Priority Data
Oct. 6, 2011 (TW) 100136359

(51) Int. Cl. G06F 9/45; G06F 9/44

(52) U.S. Cl. 717/121

(57) ABSTRACT

In a method for processing source files using a computing device, a source file and a configuration file is downloaded from a server. The method reads each line of instructions from the configuration file. A replacement string is generated according to a predetermined prefix name from the configuration file and information of an operating system of the computing device. A name of the source file is obtained from the configuration file, and a name of an execution file corresponding to the source file is obtained according to the replacement string. The method notifies a compiling unit reading and compiling the source file according to the name of the source file, and generates the execution file with the name of the execution file.

### BACKGROUND

1. Technical Field

Embodiments of the present disclosure relate to compilation systems and methods, and more particularly to a computing device, a storage medium and a method for processing source files using the computing device.

2. Description of Related Art

Compatibility of software developed under a platform of an open source system (e.g. a LINNUX operating system) may not be good enough because of incompatible factories with different operating systems. For example, one execution file compiled by a provider may not be executed by an operating system of a second provider, and the execution file should be copied to the operating system of the second provider to be recompiled. In order to save time of recompilation, compilation commands of the recompilation are stored as description files that are executed directly to be recompiled by the execution file. However, a large number of description files may be generated when the execution files are executed by different systems. It is very inconvenient to use and manage the description files.

### BRIEF DESCRIPTION OF THE DRAWINGS

FIG. 1 is a block diagram of one embodiment of a plurality of computing devices.

FIG. 2 is a block diagram of function modules of the processing system included in each of the computing devices of FIG. 1.

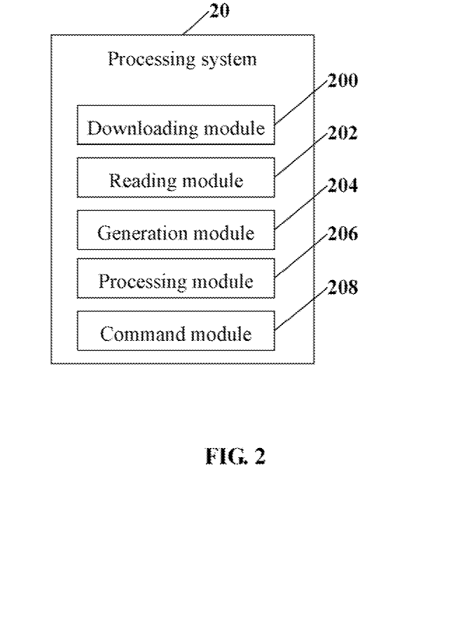

FIG. 3 is a flowchart of one embodiment of a method for processing source files using the computing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

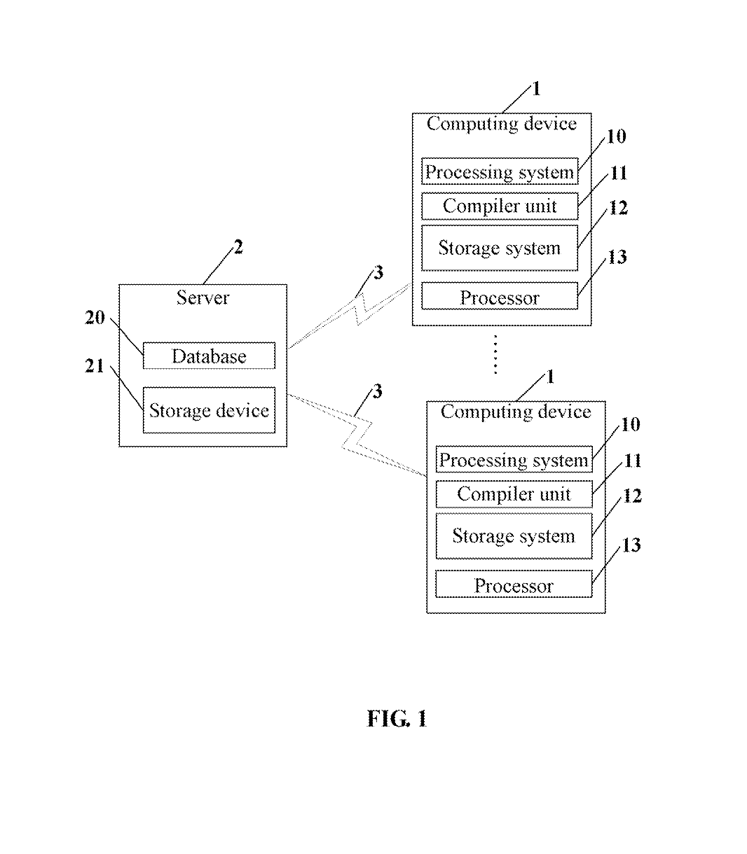

FIG. 1 is a block diagram of one embodiment of a plurality of computing devices 1.

In the embodiment, each of the computing devices 1 is comprises a processing system 10, and communicates with a server 2 through a network 3, such as a wireless network, for example. Each of the computing devices 1 has an operating system. In one embodiment, the operating system may be a LINUX operating system, such as, Red Hat 4, Red Hat 5, or SUSE 10, for example. The server 2 offers different source files with one or more source programs. In one embodiment, each of the computing devices 1 is a compiling device that compiles the source files, and the server 2 is a source computing device that offers the source files.

Each of the computing devices 1 includes a compiler unit 11, a storage system 12 and at least one processor 13. The compiler unit 11 compiles the source files and generates execution files that can be executed by each of the computing devices 1. The compiler unit 11 in each of the computing devices 1 has an identical name. The storage system 12 stores information of the operating system of the computing device 1. In one embodiment, the information of the operating system includes an abbreviated name of the operating system and a number of bits of the operating system for a central processing unit (not shown in FIG. 1) of the computing device 1. The abbreviated name is shortened for a name and a version number of the operating system. For example, if the operating system is Red Hat 4, and the number of bits is 32-bit, the storage system 12 may store the information of the operating system to be the abbreviated name with RH4, and the number of bits with 32. The at least one processor 13 executes one or more computerized codes and other applications of the computing device 1, to provide functions of the processing system 10.

The server 2 includes a database 20 and a storage device 21. The database 20 stores the plurality of source files, and the storage device 21 stores a configuration file for setting compilation parameters. The processing system 10 compiles the source file using the compiler unit 11, generates the execution file executed by the computing device 1 according to the configuration file, and generates the execution files with correct file names according to the information of the operating system of the computing device 1.

In one embodiment, the compilation parameters of the configuration file includes a predetermined prefix name of the execution file to be generated by the complier unit 21, the name of the complier unit 21, a name of the source file to be compiled by the complier unit 21, and a replacement keyword of the execution file. The replacement keyword represents a replacement of the name of the execution file, such as, %fname%, for example. The configuration file includes a plurality of lines of instructions (or codes) for setting the compilation parameters, such as, shell instructions. In the embodiment, the first line of the configuration file is the predetermined prefix name. For example, the configuration file may be defined as:

“abc gcc main.c-o%fname%”. The “abc” is the predetermined prefix name of the execution file.
The “gcc” is the name of the complier unit 21. The “mian.c” is the name of the source file to be compiled by the complier unit 21. The “-o %fname%” represents that the name of the execution file generated by the complier unit 21 is “%fname%”. Details will be described as follows:

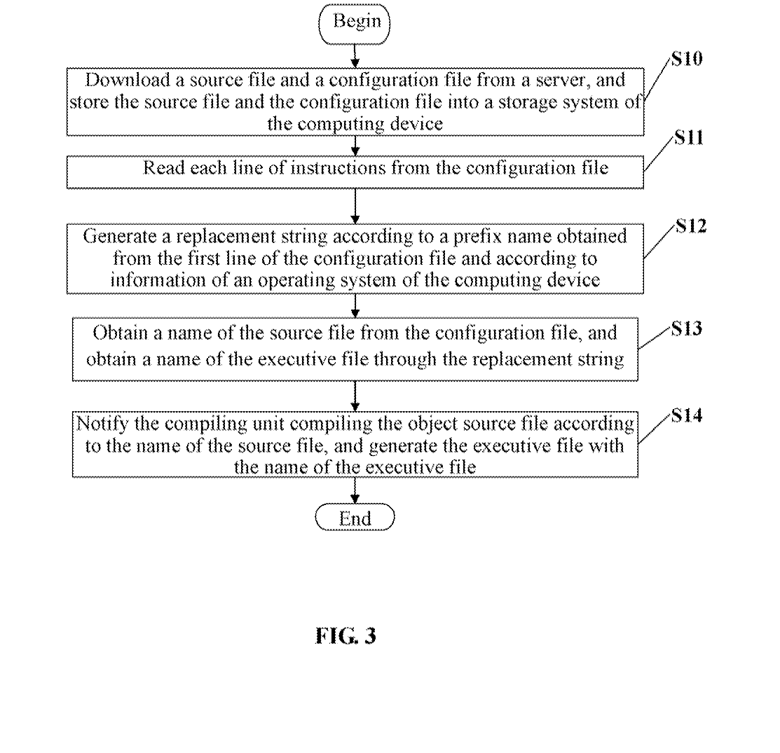

In the embodiment, the processing system 10 may include a downloading module 200, a reading module 202, a generation module 204, a processing module 206, and a command module 208. The modules 200, 202, 204, 206, and 208 comprise computerized codes in the form of one or more programs that are stored in the storage system 12. The computerized codes include instructions that are executed by the at least one processor 13 to provide functions for the modules. Details of each of the modules will be given in FIG. 3.

FIG. 3 is a flowchart of one embodiment of a method for processing source files using the computing devices 1 of FIG. 1. Depending on the embodiment, additional blocks may be added, others deleted, and the ordering of the blocks may be changed.

In block S10, when each of the computing devices 1 receives a downloading command from the server 2, the downloading module 200 downloads a source file and a configuration file from the database 20, and stores the source file and the configuration file into the storage system 12. In one embodiment, the downloading command includes a storage path of the source file.

In block S11, the reading module 202 reads each line of instructions from the configuration file. As mentioned above, the configuration file includes a plurality of lines of instructions (or codes) for setting compilation parameters, such as, shell instructions.

In block S12, the generation module 204 obtains the predetermined prefix name of an execution file corresponding to the source file after reading the first line of instruction of the configuration file, and generates a replacement string according to the predetermined prefix name and the information of the operating system in the storage system 12. In one embodiment, the generation module 204 generates the replacement string according to the predetermined prefix name, the abbreviated name of the operating system, and the number of bits of the operating system. For example, if the first line of the configuration file is “abc”, and the storage system 12 stores the information of the operating system that includes the abbreviated name with RH4, and the number of bits with 32, the generation module 204 generates the replacement string to be “abc_RH4_{—}32”.

In block S13, the processing module 206 obtains a name of the source file when the name of the compiler unit 11 has read, and obtains the replacement string as a name of the execution file through replacing the replacement keyword with the replacement string. In one embodiment, once the reading module 206 reads the replacement keyword, the processing module 206 replaces the replacement keyword with the replacement string.

In block S14, the command module 208 notifies the compiling unit 21 to read and compile the source file from the storage system 12 according to the name of the source file, and generates the execution file with the obtained name of the execution file. The compiling unit 21 generates the execution file to store in a predetermined storage location of the computing device 1. If each of the computing devices needs to execute the execution file on the computing device 1 the computing device 1 may download the execution file according to the operating system through the network 3.

All of the processes described above may be embodied in, and be fully automated via, functional code modules executed by one or more general-purpose processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A computer-implemented method for processing source files using a computing device, the computing device connecting to a server, the method comprising:
downloading a source file and a configuration file from the server, and storing the source file and the configuration file into a storage system of the computing device;
reading each line of instructions from the configuration file;
obtaining a predetermined prefix name of an execution file corresponding to the source file after reading the first line of the configuration file, and generating a replacement string according to the predetermined prefix name and information of an operating system of the computing device;
obtaining a name of the source file from the configuration file when reading a name of a compiling unit of the computing device, and obtaining a name of the execution file from the configuration file;
notifying the compiling unit to compile the source file from the storage system according to the name of the source file, and generating the execution file with the name of the execution file.

2. The method as claimed in claim 1, wherein the configuration file comprises compilation parameters for compiling the source file, and the compilation parameters comprise the predetermined prefix name of the execution file, the name of the complier unit, the name of the source file, and a replacement keyword of the execution file.

3. The method as claimed in claim 2, wherein the name of the execution file is obtained by replacing the replacement keyword of the execution file with the replacement string.

4. The method as claimed in claim 1, wherein the information of the operating system comprise an abbreviated name and a number of bits of the operating system, and the abbreviated name is shortened for a name and a version number of the operating system.

5. The method as claimed in claim 4, wherein the replacement string is generated according to a predetermined prefix name, the abbreviated name of the operating system, and the number of bits of the operating system.

6. The method as claimed in claim 1, wherein the compiling unit compiles the source file and generates the execution file that is executed by the operating system, and storing the execution file in a storage device of the server.

7. A non-transitory storage medium storing a set of instructions, when executed by at least one processor of a computing device, cause the at least one processor to perform a method for process a source file using the computing device, the method comprising:
downloading the source file and a configuration file from the server, and storing the source file and the configuration file into a storage system of the computing device;
reading each line of instructions from the configuration file;
obtaining a predetermined prefix name of an execution file corresponding to the source file from the configuration file, and generating a replacement string according to the predetermined prefix name and information of an operating system in the storage system of the computing device;
obtaining a name of the source file from the configuration file when reading a name of a compiling unit of the computing device, and obtaining a name of the execution file according to the replacement string;
notifying the compiling unit compiling the source file from the storage system according to the name of the source file, and generating the execution file with the name of the execution file.

8. The storage medium as claimed in claim 7, wherein the configuration file comprises compilation parameters for compiling the source file, and the compilation parameters comprise the predetermined prefix name of the execution file, the name of the complier unit, the name of the source file, and a replacement keyword of the execution file.

9. The storage medium as claimed in claim 8, wherein the name of the execution file is obtained by replacing the replacement keyword of the execution file with the replacement string.

10. The storage medium as claimed in claim 7, wherein the information of the operating system comprise an abbreviated name and bit number of the operating system, and the abbreviated name is shortened for a name and a version number of the operating system.

11. The storage medium as claimed in claim 10, wherein the replacement string is generated according to a predetermined prefix name, the abbreviated name of the operating system, and the bit number of the operating system.

12. The storage medium as claimed in claim 7, wherein the compiling unit compiles the source file and generates the execution file that is executed by the operating system, and storing the execution file in a storage device of the server.

13. A computing device, comprising:
a storage system;
at least one processor; and
one or more programs that are stored in the storage system and executed by the at least one processor, the one or more programs comprising:
a downloading module that downloads a source file and a configuration file from the server, and stores the source file and the configuration file into a storage system of the computing device;
a reading module that reads each line of instructions from the configuration file;
a generation module that obtains a predetermined prefix name of an execution file corresponding to the source file from the configuration file, and generates a replacement string according to the predetermined prefix name and information of an operating system in the storage system of the computing device;
a processing module that obtains a name of the source file from the configuration file when reading a name of a compiling unit of the computing device, and obtaining a name of the execution file according to the replacement string;
a command module that notifies the compiling unit to compile the source file from the storage system according to the name of the source file, and generating the execution file with the name of the execution file.

14. The computing device as claimed in claim 13, wherein the configuration file comprises compilation parameters for compiling the source file, and the compilation parameters comprise the predetermined prefix name of the execution file, the name of the complier unit, the name of the source file, and a replacement keyword of the execution file.

15. The computing device as claimed in claim 13, wherein the name of the execution file is obtained by replacing the replacement keyword of the execution file with the replacement string.

16. The computing device as claimed in claim 13, wherein the information of the operating system comprise an abbreviated name and bit number of the operating system, and the abbreviated name is shortened for a name and a version number of the operating system.

17. The computing device as claimed in claim 16, wherein the replacement string is generated according to a predetermined prefix name, the abbreviated name of the operating system, and the bit number of the operating system.

18. The computing device as claimed in claim 13, wherein the compiling unit compiles the source file and generates the execution file that is executed by the operating system, and storing the execution file in a storage device of the server.
